(19) United States
(12) Patent Application Publication
(10) Pub. No.: US 2024/0429860 A1
(43) Pub. Date: Dec. 26, 2024

(54) LOCATION DETERMINATION IN A PHOTOVOLTAIC SYSTEM

(71) Applicant: Tigo Energy, Inc., Campbell, CA (US)

(72) Inventors: Eugene Talapa, Campbell, CA (US); Benjamin Victor Duane Henry, Los Gatos, CA (US); Daniel Eizips, Sunnyvale, CA (US); Shmuel Sam Arditi, Discovery Bay, CA (US)

(21) Appl. No.: 18/620,472

(22) Filed: Mar. 28, 2024

Related U.S. Application Data
(63) Continuation-in-part of application No. 18/337,632, filed on Jun. 20, 2023.

(51) Int. Cl. H02S 50/00; H02J 3/38; H02J 7/34; H02S 40/32; H02S 40/36

(52) U.S. Cl. CPC H02S 50/00; H02J 3/381; H02J 7/345; H02S 40/32; H02S 40/36; H02J 2300/24

(57) ABSTRACT

A system includes a plurality of photovoltaic modules; an inverter; and a controller configured to generate a signal to be transmitted to a local management unit connected to at least one of the plurality of photovoltaic modules. A first local management unit is configured to receive a communication signal from the controller. The first local management unit is configured to output a message to all other connected local management units. A second local management unit is configured to receive the communication signal from the first local management unit and to output a second message to the first local management unit. The controller is configured to identify a location of the second local management unit using the second message sent to the first local management unit and store the location in a memory of the controller.

### CROSS-REFERENCE TO RELATED APPLICATIONS

This application is a continuation-in-part of U.S. application Ser. No. 18/337,632, filed on Jun. 20, 2023, and titled “LOCATION DETERMINATION IN A PHOTOVOLTAIC SYSTEM,” the entire contents of which are hereby incorporated by reference.

### FIELD OF THE TECHNOLOGY

At least some embodiments disclosed herein relate generally to photovoltaic systems. More specifically, the embodiments relate to estimation of a location of one or more panels in a photovoltaic system or improving communication in such a system.

### BACKGROUND

Photovoltaic systems can include at least one string of photovoltaic panels. A location of the photovoltaic panels within the photovoltaic system may not always be known. Photovoltaic systems may require maintenance. In some cases, the photovoltaic systems can include a large number of strings. In such cases, it can be difficult to navigate to the appropriate one of the photovoltaic panels requiring maintenance without knowing a location of the photovoltaic panel with the photovoltaic system. Improved ways of determining a location within the photovoltaic system of particular photovoltaic panels may be beneficial. In some large systems, communication may be difficult. Improved communication may be desirable.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 shows a schematic diagram of a photovoltaic system, according to some embodiments.

FIG. 2 shows a flowchart of a method to determine a location of a panel (solar module) in a photovoltaic system, according to some embodiments.

FIG. 3 shows a flowchart of a method to determine a location of a panel in a photovoltaic system, according to some embodiments.

FIG. 4 shows a schematic diagram of a photovoltaic system, according to some embodiments.

FIG. 5 shows a flowchart of a method to determine a location of a panel in a photovoltaic system, according to some embodiments.

FIG. 6 shows a schematic diagram of a photovoltaic system, according to some embodiments.

FIG. 7 shows a schematic diagram of a photovoltaic system, according to some embodiments.

FIG. 8 shows a schematic diagram of a photovoltaic system, according to some embodiments.

FIG. 9 shows a schematic diagram of a photovoltaic system, according to some embodiments.

### DETAILED DESCRIPTION

The present disclosure relates to a photovoltaic system. Various detailed embodiments of the present disclosure, taken in conjunction with the accompanying figures, are disclosed herein. It is to be understood that the disclosed embodiments are merely illustrative. In addition, each of the examples given in connection with the various embodiments of the present disclosure is intended to be illustrative, and not restrictive.

A large installation of photovoltaic panels can involve multiple sets of power lines connected to multiple strings or groups of photovoltaic panels respectively. In some cases, it is not possible to know an exact location of the different photovoltaic panels in the installation. However, such information can be useful. For example, if there is a problem with one of the photovoltaic panels in the system, it would be beneficial to be able to decipher where that photovoltaic panel is located so that, for example, a technician or the like can navigate directly to the proper location. In some embodiments, especially when the photovoltaic system is located on a roof or is otherwise difficult to traverse between photovoltaic panels, such location determination can also be useful in increasing a safety to the technician, decreasing efforts of the technician, or the like.

Embodiments of this disclosure are directed to systems and methods for determining a location of a photovoltaic panel within a photovoltaic system. In some embodiments, the location can be inferred based on a relative communication signal current at local management units of respective photovoltaic panels. For example, a photovoltaic panel connected closest to a Power Line Communication (PLC) transmitter in the system may have a relatively higher communication signal current, with each photovoltaic panel along the string of the photovoltaic system having a relatively lower communication current. For example, in a photovoltaic system having four panels A, B, C, D, with panel A being closest to the PLC transmitter and panel D being furthest, the current input of panel A may be greater than the current input of panel B, which is greater than the current input of panel C, which is greater than the current input of panel D. As a result, the current values can be used to determine the relative location of the panels A, B, C, or D within the photovoltaic system. In some embodiments, the decrease in input communication current can be a result of, for example, losses attributed to a local management unit (LMU) for the individual photovoltaic panel or module level power electronics (MLPE). In some embodiments, the relative locations within the string of photovoltaic panels can be used in conjunction with, for example, a blueprint of the system to determine an exact geographical location of the photovoltaic panel within the photovoltaic system. The current of the signal can be a communication current, which is not a direct current (DC) and is not high power.

In some embodiments, the four panels A, B, C, D (in the above example) can additionally or alternatively include a wireless input/output that communicates with one or more antennas, a wireless receiver, a wireless transmitter device, or combinations thereof, in the system. In such embodiments, a signal strength between the respective panel and the antenna, wireless receiver, or transmitter device could be utilized to determine relative distances from the antenna, wireless receiver, or transmitter device and thus establishing the relative location of the photovoltaic panels in the photovoltaic system. In some embodiments, the relative locations within the string of photovoltaic panels can be used in conjunction with, for example, a blueprint of the system to determine an exact geographical location of the photovoltaic panel within the photovoltaic system.

In some embodiments, both a current input and a wireless signal strength can be used.

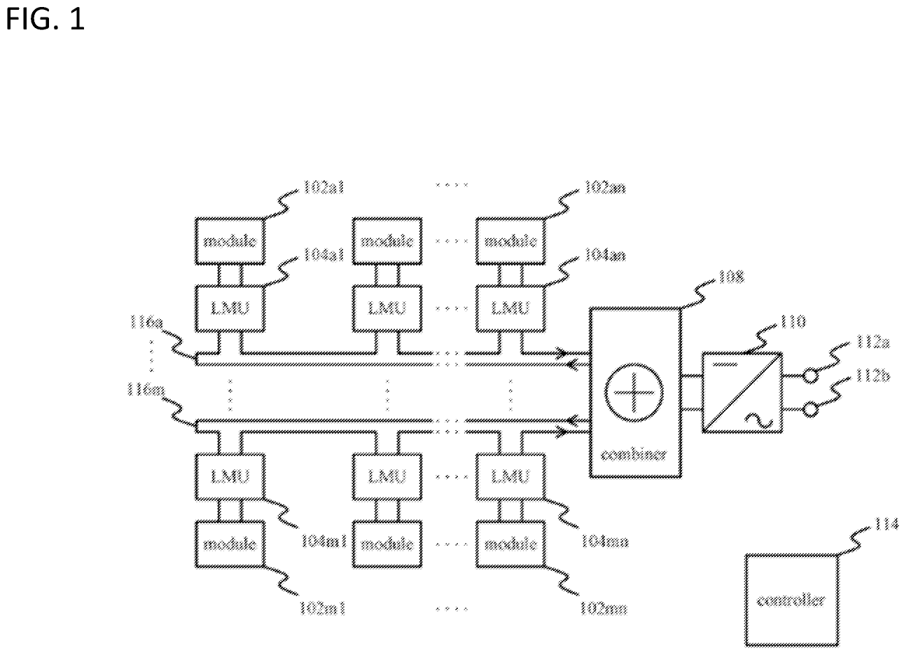

FIG. 1 shows a schematic diagram of a photovoltaic system 100, according to some embodiments.

FIG. 1 is a schematic structural diagram illustrating strings of photovoltaic (PV) modules 102 in a PV array, according to some embodiments.

PV modules 102a1 through 102an may each hold one or more PV cells. A group of PV modules 102a1 through 102an connected together can be referred to as a string of PV modules or a string of solar modules. Strings of PV modules 102 can be wired in series via a “string” or power bus 116a through 116m to produce a required output voltage. A PV array, or solar array, may contain multiple strings 116a through 116m of PV modules 102a1 through 102an.

PV modules 102a1 through 102an may be connected to the strings 116a through 116m via local management units (LMUs) 104a1 through 104an, respectively. The LMUs 104a1 through 104an may also be referred to as solar module controllers, solar module converters, or link module units. The LMUs 104a1 through 104an may include a solar module controller to control the operation of the PV module, to monitor a status of the respective PV module, and to link the respective PV module to the serial power bus for energy delivery and safety. The LMUs 104a1 through 104an may also perform filtering, disconnect, DC conversion, or combinations thereof, for example, to buck or boost a module output voltage to a desired string voltage, of the power output by their respective solar modules to the strings.

In some embodiments, the LMUs 104a1 through 104an may use the power bus for sending data and communications. In some embodiments, the LMUs 104a1 through 104an may be connected to a separate communication network, either via wires or wirelessly. In some embodiments, the LMUs 104a1 through 104an may use the power bus and one or more of a wired or wireless network for sending data and communications. In some embodiments, an LMU may be configured to operate more than one PV module. For example, an LMU could be configured to operate each solar panel in a solar array, where each solar panel includes two or more solar modules.

The LMUs 104a1 through 104an may be connected on one side to the solar modules 102a1 through 102an in parallel, and on the other side in series to strings 116a through 116m. The LMUs 104a1 through 104an may receive different types of input communications, for example, a requested duty cycle, which can be expressed as a percentage (e.g., from 0% to 100%) of time the solar module is to be connected to the serial power bus, a phase shift in degrees (e.g., from 0 degrees to 180 degrees), a timing or synchronization pulse, a pairing communication, or combinations thereof. These inputs can be supplied, for example, as discrete signals, or can be supplied as data on a network, or composite signals sent through the power lines 116a to 116m, or wirelessly, and in yet other cases, as a combination of any of these input types.

In some embodiments, the LMUs 104a1 through 104an may also monitor a status of the PV modules 102a1 through 102an, for example, by monitoring sensors which give operating parameters of the module such as voltage, current, temperature, combinations thereof, or the like. In some embodiments, the LMUs 104a1 through 104an may also monitor local meteorological conditions, for example, such as solar irradiance, air temperature, and the like. The LMUs 104a1 through 104an may be configured to optimize an operation of their respective PV module using the status of the PV module determined by the monitoring.

In some embodiments, the LMUs 104a1 through 104an can shut down the solar module based on one or more triggers determined by the monitoring, for example, an overvoltage, a high temperature, or the like, or based on an emergency shutdown signal received from the controller 114. In some embodiments, the controller 114 may output a system OK signal, and the LMUs 104a1 through 104an shut down their respective solar module if the system OK signal is not received for a predetermined period of time, for example, 10 seconds.

In some embodiments, the LMUs 104a1 through 104an may communicate the status of the solar modules 102a1 through 102an and local meteorological conditions to a controller 114. The controller 114 may then determine and generate the input communications for driving the LMUs, for example, a duty cycle, a phase shift, a timing or synchronization pulse, a pairing communication, combinations thereof, or the like, based at least in part on the statuses of the PV modules and the meteorological conditions to optimize a performance of the solar array.

In some embodiments, the controller 114 can cause the LMUs 104a1 through 104an to shut down their respective PV module based on one or more triggers determined by the monitoring, for example, an overvoltage, a high temperature, or the like, or based on an emergency shutdown signal generated by and sent from the controller 114. The controller 114 generates and sends the emergency shutdown signal, which may be based on an overvoltage in a combiner or an inverter, a condition at connectors 112a and 112b, for example, to a main power grid or local system, or an external factor, such as a fire alarm, seismic alarm, or the like. In some embodiments, the controller may generate and output a system OK signal, and the LMUs 104a1 through 104an shut down their respective solar module automatically if the system OK signal is not received for a predetermined period of time, for example, 10 seconds.

In some embodiments, the controller 114 can receive one or more input communication current values from the LMUs 104a1 through 104an. In some embodiments, the controller 114 can determine, based on the input communication current values from the LMUs 104a1 through 104an a relative location of the LMUs 104a1 through 104an to each other and, accordingly, a relative location of the corresponding modules. For example, a PLC current value determined by LMU 104an can be relatively larger than a PLC current value determined by LMU 104a1. In such embodiments, it can be inferred that the LMU 104an is relatively closer to a beginning of the string than LMU 104a1. In some embodiments, with this information, a blueprint of the photovoltaic system 100 can be used to determine an exact location of the particular LMU and corresponding solar module within the photovoltaic system 100.

In some embodiments, the LMUs 104a1 through 104an can be in wireless communication with the controller 114. In some embodiments, the controller 114 can test a signal strength of the respective LMUs. The signal strength can be used to infer an order of the LMUs and their relative location from the controller 114 or an antenna, wireless receiver, or other transmitter device within the photovoltaic system 100. In some embodiments, with this information, a blueprint of the photovoltaic system 100 can be used to determine an exact location of the particular LMU and corresponding solar module within the photovoltaic system 100. In some embodiments, two parallel strings can have similar signal strength values for their respective LMUs. For example, a first string can have signal strengths of 1, 0.5, and 0.25 and a second string can have signal strengths of 0.9, 0.4, and 0.15. Ordering such a list directly would mean that the signal strengths of the first string may get intermixed with the signal strengths of the second string. In such embodiments, stringing may first be determined then the signal strengths ordered (or by testing each string independently).

In some embodiments, the controller 114 can use both the input communication current values and the signal strength. In some embodiments, the controller 114 can use the input communication current values without using the signal strength. In some embodiments, the controller 114 can use the signal strength without the input communication current values. In some embodiments, the controller 114 can store the locations in memory of the controller 114. In some embodiments, the controller 114 can output the locations via a network to a remote storage device.

The strings 116a through 116m are collected in combiner 108. The combiner 108 collects the DC power from the strings 116a through 116m and supplies DC power to a central inverter 110. The inverter 110 may have filters and capacitors on the input side. A capacitance of the central inverter 110 varies by application; however, in general, there can be a very large capacitance on the input side of an inverter in solar energy applications. Even when the system is shutdown, for example, when a power grid to which the solar array is supplying energy is shutdown, a problem remains that the capacitors on the input side of the central inverter may still be holding a dangerous amount of charge.

The controller 114 may include a microcontroller or small single chip microcontroller (SCMC), for example, or may be implemented using an Application-Specific Integrated Circuit (ASIC), Field-Programmable Gate Array (FPGA), or other programmable logic. The controller 114 can even be implemented in discrete, functionally equivalent circuitry, or in other cases a combination of SCMC and discrete circuitry.

The controller 114 may be a stand-alone unit, or may be integrated with the combiner 108, with the inverter 110, or with both the combiner and the inverter into a single unit. In some embodiments, the controller 114 is integrated with the inverter 110, monitors a performance of the inverter 110, determines and tracks a maximum power point, and controls the LMUs 104a1 through 104an based on, at least in part, the maximum power point. Further, while depicted as a logical unit for purposes of this disclosure, the controller 114 may be a distributed device.

For example, the controller 114 could include maximum power point tracking (MPPT) circuitry integrated with inverter 110, local control circuitry integrated with LMUs 104a1 through 104an or with the individual PV modules 102a1 through 102an, and a stand-alone microcontroller unit (MCU) which communicates with and controls the MPPT and local circuit elements. The MPPT calculations by the MCU may be performed, for example, using one or more known MPPT algorithms such as perturb-and-observe, incremental conductance, current sweep, or constant voltage. The MPPT algorithms find the operating voltage that allows a maximum power output from the inverter. The controller 114 could also include multiple controllers, for example, with each controller being responsible for a string, or for one or more solar modules on a solar panel.

The embodiment of FIG. 1 is a common arrangement of a photovoltaic solar array system, wherein the solar modules 102a1 through 102mn supply DC power to the strings 116a through 116m. The power is collected by the combiner 108, and then supplied to the inverter 110. While this is one arrangement with which the teachings of the present disclosure may be practiced, it is not the only such arrangement.

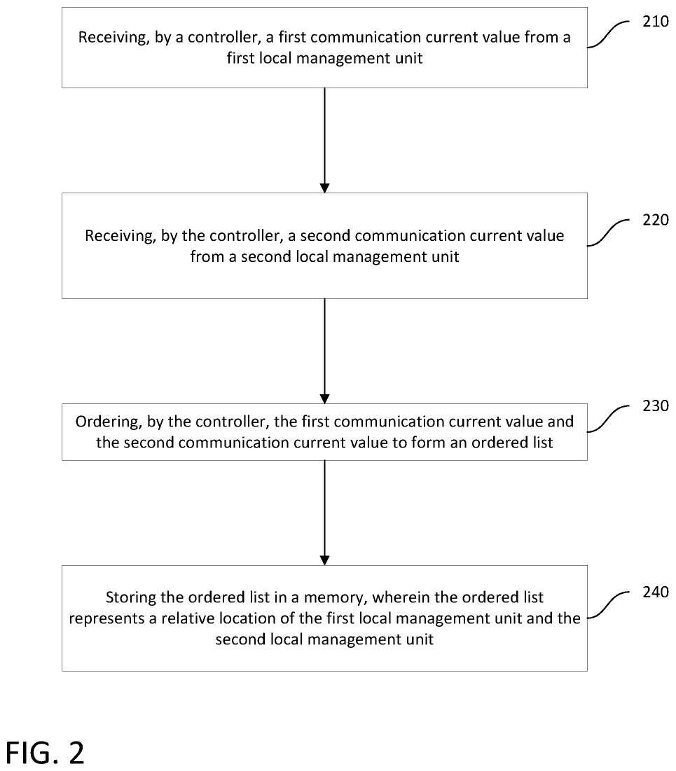

FIG. 2 shows a flowchart of a method 200 to determine a location of a panel in a photovoltaic system, according to some embodiments. In some embodiments, the method 200 can be used to determine a location of a solar module 102a1 through 102an in the photovoltaic system 100 of FIG. 1.

At block 210, the method 200 includes receiving, by a controller, a first PLC current value from a first local management unit. In some embodiments, the first current value is representative of a first input communication current of a PLC transmitter to a first photovoltaic module in a photovoltaic system.

At block 220, the method 200 includes receiving, by the controller, a second current value from a second local management unit. In some embodiments, the second current value representative of a second input communication current to a second photovoltaic module in the photovoltaic system.

At block 230, the method 200 includes ordering, by the controller, the first current value and the second current value to form an ordered list. In some embodiments, the ordered list can be from ordered from largest to smallest. In some embodiments, the ordered list can be ordered from smallest to largest. In some embodiments, the ordered list can be created as a single list for each of the strings in the photovoltaic system. In some embodiments, this can prevent ordering current values from different strings together, which can lead to inaccurate identification.

At block 240, the method 200 includes storing the ordered list in a memory, wherein the ordered list represents a relative location of the first photovoltaic module and the second photovoltaic module within a string in the photovoltaic system. In some embodiments, the memory can be onboard the controller, the transmitter, the first local management unit, the second local management unit, or combinations thereof. In some embodiments, a largest value in the ordered list is representative of a closest local management unit (and corresponding solar module) to the beginning of the string in the photovoltaic system.

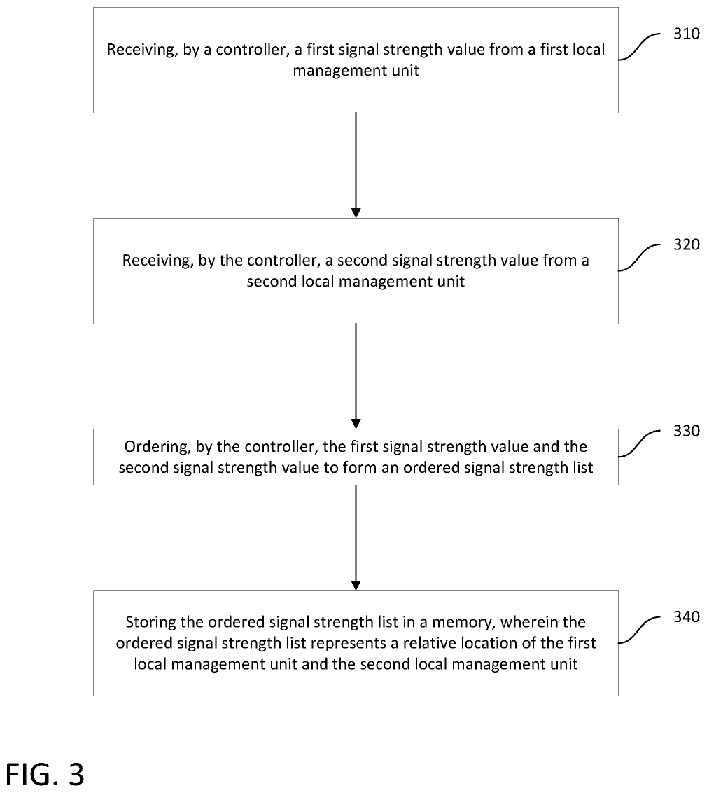

FIG. 3 shows a flowchart of a method 300 to determine a location of a panel in a photovoltaic system, according to some embodiments. In some embodiments, the method 300 can be used to determine a location of a solar module 102a1 through 102an in the photovoltaic system 100 of FIG. 1.

At block 310, the method 300 includes receiving, by a controller, a first signal strength value from a first local management unit. In some embodiments, the signal strength of the LMU transmitting to a receiver can be determined by the receiver. A receiver can include any device receiving or transmitting communication to or from the LMU or LMUs. In some embodiments, a receiver can be part of a controller and can accordingly be referred to as a controller. In some embodiments, the first signal strength value is representative of a signal strength for the first local management unit to communicate with the controller (or antenna, wireless receiver, or other transmitter device) in a photovoltaic system. In some embodiments, the controller can be part of an inverter in the photovoltaic system. In some embodiments, the controller can be separate from the inverter in the photovoltaic system.

At block 320, the method 300 includes receiving, by the controller, a signal strength value from a second local management unit. In some embodiments, the second signal strength value is representative of a second signal strength for the second local management unit to communicate with the controller.

At block 330, the method 300 includes ordering or calculating, by the controller, the first signal strength value and the second signal strength value to form an ordered signal strength list.

At block 340, the method 300 includes storing the ordered signal strength list in a memory. In some embodiments, the memory can be onboard the controller, the transmitter, the first local management unit, the second local management unit, or combinations thereof. In some embodiments, the ordered signal strength list represents a relative location of the first photovoltaic module and the second photovoltaic module compared to the controller. In some embodiments, the highest signal strength value within the ordered signal strength list is representative of the corresponding local management unit that is relatively closest to the receiver.

In some embodiments, the method 200 and the method 300 can be combined. For example, in some embodiments, the controller can track both the PLC current values and the signal strengths for the local management units within the photovoltaic system. In some embodiments, the controller can be configured to rely on the input communication current values as having a higher priority than the wireless signal strengths. In some embodiments, the controller can be configured to rely on the wireless signal strengths as having a higher priority than the input communication current values. In some embodiments, the controller can rely on the value having the higher priority in situations in which the results are inconsistent.

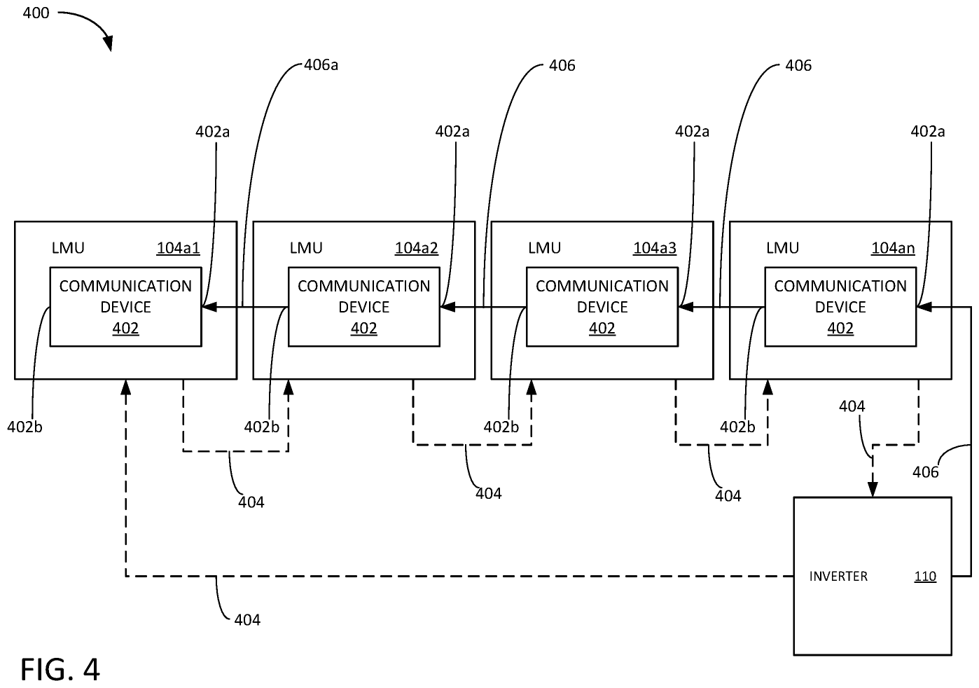

FIG. 4 shows a schematic diagram of a photovoltaic system 400, according to some embodiments.

In some embodiments, the photovoltaic system 400 can be the same as or similar to the photovoltaic system 100. In addition to the aspects of the photovoltaic system 100 discussed above, the photovoltaic system 400 includes a communication device 402 within each of the LMUs 104an. The communication device 402 is connected via a communication line directly to another of the LMUs 104an. As a result, power and communications are performed in separate lines, either power lines 404 (represented as dashed lines) or communication lines 406 (represented as solid lines). The communication lines 406 are not a communication bus. The communication lines 406 do not use a power line communication (PLC). Instead, the communications are point-to-point between the LMUs 104an. As a result, a communication line 406a is connected to LMU 104a1, but not LMU 104a3. That is, the communication line 406a is connected to LMU 104a1 but not to other LMUs 104a3 and 104an.

Each communication device 402 has an input 402a and an output 402b to a neighboring LMU 104an. In some embodiments, it is possible to know which LMU 104an is closest to the inverter 110 and which one is further away. In some embodiments, this knowledge can make it possible to automatically map locations of the LMUs 104an.

In some embodiments, the communication device 402 can enhance communication reliability in the photovoltaic system 400. As the line between the LMUs is shorter and goes only between 2 LMUs 104an, it comes with an improved communication reliability compared to prior methods. Generally, in an RS-485 bus or PLC, the line goes between several LMUs and many LMUs are connected to that bus, which can reduce reliability. Reliability may especially be degraded when there are few PLC transmitters in proximity as it is possible to create crosstalk between the lines. These long lines may also be degraded by electrical noise generated by the inverter 110 or nearby utility transformers and other equipment. In some cases, the communication may especially be degraded as the PLC is not only transferring communication but is also transferring the power which has inherent electronic noise.

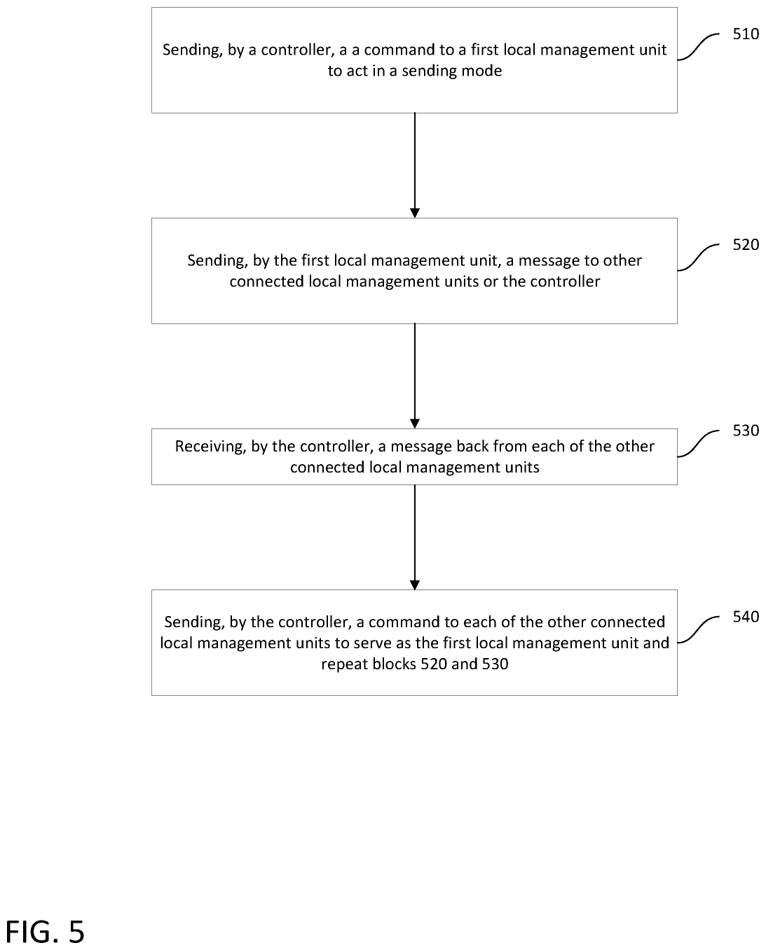

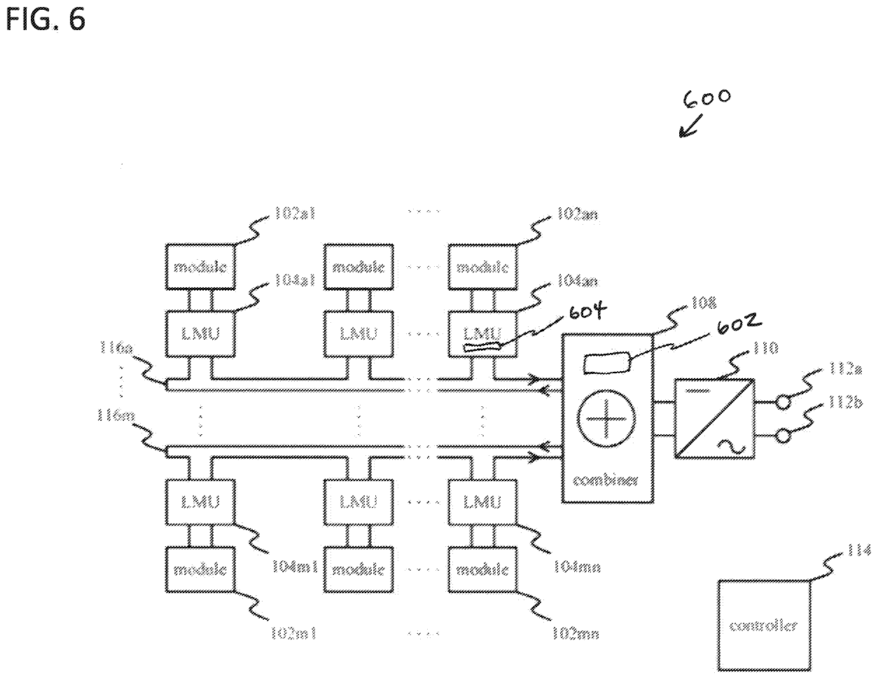

FIG. 5 shows a flowchart of a method 500 to determine a location of a panel in a photovoltaic system, according to some embodiments. In some embodiments, the method 500 can be used to determine a location of a solar module 102a1 through 102mn in the photovoltaic system 100 of FIG. 1 or the photovoltaic system 600 of FIG. 6. In some embodiments, the method 500 can use a disturbance generator to create a disturbance such as a drop in current in an amount that is atypical from normal operation. As a result of the drop in current (e.g., limiting the current to half the normal amount), LMUs on a same string as the disturbance see a similar current drop or disturbance. It is to be appreciated that the current being limited to half the normal amount is just an example and that other changes can be made within the scope of the present disclosure (e.g., reducing to less than half the normal amount, more than half the normal amount, etc., or different disturbances). As a result, a controller of the photovoltaic system is able to determine which LMUs are on the same string based on which LMUs experience the same current drop or disturbance. Consequently, other strings within the photovoltaic system will see a voltage spike due to the current drop or disturbance. In some embodiments, instead of watching for a voltage spike, the other strings can be looking for mirrored disturbances in the current measurements (e.g., same current measurements, but with a mirrored signal). In some embodiments, if the pattern is digital, then the pattern may be bit-inverted. The controller will also be able to determine the location of the other strings as being separate from the string in which the current drop or disturbance was generated. Additionally, in a photovoltaic system having multiple inverters, the controller will also be able to determine which strings do not see a current or voltage change and will be able to decipher that these corresponding strings and inverter(s) are disposed separately from the string and inverter on which the disturbances occur. In some embodiments, if an LMU identifies a current drop or disturbance, the LMU can send an encoded message to the controller and if an LMU identifies a voltage spike (mirrored disturbance, or bit-inverted message), the LMU can send a different encoded message to the controller.

At block 510, the method 500 includes sending, by a controller, a command to a first LMU to act in a sending mode in which the controller will send an arbitrary message to other LMUs connected to the first LMU. The other LMUs may be connected in parallel or in series to the first LMU.

At block 520, the method 500 includes sending, by the first LMU, an arbitrary message to the other LMUs connected to the first LMU. In some embodiments, all LMUs in the same string will receive the same message. In some embodiments, all LMUs that are connected in parallel will receive a bit-inverted message. In some embodiments, the message being sent can be generated by creating a current fluctuation or disturbance at the first LMU. For example, in some embodiments, the current fluctuation or disturbance can be generated using the buck converter of the first LMU (e.g., by varying the duty cycle of the buck converter). In some embodiments, the current fluctuation or disturbance can be made by decreasing and increasing the PWM duty cycle, decreasing and increasing the string's total voltage, thereby making current flow follow a similar pattern. It is to be appreciated that this fluctuation or disturbance should be conducted at a rate that is fast enough to prevent the inverter from adjusting to a new working point. In some embodiments, the fluctuation or disturbance should not trip any arc fault interrupter (AFCI) in the system. In some embodiments, the fluctuation or disturbance should not correspond to any timing like naturally occurring events (e.g., shading due to birds flying by, leaves, trees, etc.). In some embodiments, the message may be encoded such as, but not limited to, using a Manchester encoding or the like. It is to be appreciated that other encoding options are possible within the scope of this disclosure.

At block 530, the method 500 includes receiving, by the controller, a message back from each, or some, of the other LMUs. In some embodiments, the message received is the same message that was sent by the first LMU. In some embodiments, the message received can be different. In some embodiments, the receiving can be from the other LMUs actively sending the response to the first LMU. In some embodiments, the first LMU can poll the other LMUs for a response.

At block 540, the method 500 includes sending, by the controller, a command to each of the other LMUs to repeat block 520 and 530 until all of the LMUs in the system have served as the “first LMU.” In some embodiments, the controller repeats the process until all of the LMUs have served as the first LMU. In some embodiments, the controller can repeat the process so that each of the LMUs serve as the first LMU more than once (i.e., for redundancy). In some embodiments, not every single LMU will serve as the first LMU. For example, the method may be one once on the first LMU then not again, or on a subset of the LMUs.

FIG. 6 shows a schematic diagram of a photovoltaic system 600, according to some embodiments. In some embodiments, the photovoltaic system 600 can be the same as or similar to the photovoltaic system 100 (FIG. 1) or the photovoltaic system 400 (FIG. 4). For purposes of this disclosure, the system is disclosed based on the photovoltaic system 100 (FIG. 1).

In the illustrated embodiment, in addition to the photovoltaic system 100, the photovoltaic system 600 includes at least one capacitor such as a capacitor 602 or a capacitor 604. It is to be appreciated that both are not included in some embodiments. The capacitor 602 or the capacitor 604 can be included to complete a communication loop for power line communications (PLC) at a location that is prior to the inverter 110. For example, the capacitor 602 is disposed in the combiner 108 and the capacitor 604 is disposed in the LMUs 104an. It is to be appreciated that if the capacitor 604 is disposed in the LMU 104an, only one of the LMUs 104a1-104an may include the capacitor 604. In some embodiments, the capacitor 602 or the capacitor 604 can have a small capacitance. For example, in some embodiments, the capacitance can be up to 5 uF. In some embodiments, the capacitance can be up to 1 uF. In some embodiments, the capacitance can be up to 0.75 uF. In some embodiments, the capacitance can be up to 0.5 uF. In some embodiments, the capacitance can be up to 0.4 uF. In some embodiments, the capacitance can be up to 0.3 uF. In some embodiments, the capacitance can be up to 0.25 uF. In some embodiments, the capacitance can be up to 0.22 uF. In some embodiments, the capacitance can be up to 0.2 uF. In some embodiments, the capacitance can be up to 0.1 uF.

In some embodiments, the location of the capacitor 602 or the capacitor 604 in the photovoltaic system 600 can enable for improved communications using the power line communications when, for example, there are long homerun cables used in the photovoltaic system 600. In some embodiments, long homerun cables can be at least 10 feet in length, at least 100 feet in length, at least 300 feet in length, at least 600 feet in length, or at least 900 feet in length. In some embodiments, including the capacitor 602 or the capacitor 604 in the photovoltaic system 600 can improve the power line communication signals. In some embodiments, this can increase a signal strength of the power line communication signal compared to prior methods. In some embodiments, the location of the capacitor 602 or the capacitor 604 can also reduce a needed signal power for transmitting the power line communication signal.

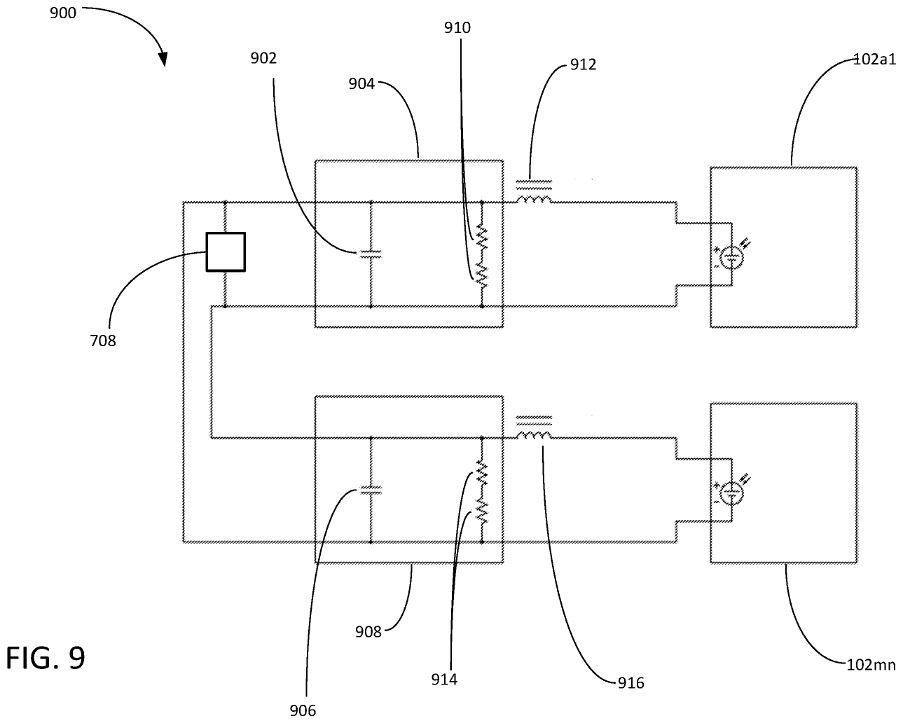

In the illustrated embodiment, the capacitor 602 is illustrated as being inside the combiner 108. It is to be appreciated that the capacitor 602 can alternatively be located outside the combiner 108 or string monitor (see FIG. 9, string monitor 904 and string monitor 908) but prior to the inverter 110. That is, in some embodiments, the capacitor 602 is between the combiner 108 or string monitor (see FIG. 9, string monitor 904 and string monitor 908) and the inverter 110.

In some embodiments, a string monitor can include a built-in capacitor. In some embodiments, the capacitor would work with the transmitter, but could be without a combiner box. In some embodiments, the transmitter will be upstream of the string monitor (e.g., between the monitor and the modules). In some embodiments, a built-in AFCI on a string side and the inverter side can detect an issue between the array and the inverter. In some embodiments, the shutdown unit will react to shutdown without waiting (e.g., within thirteen seconds).

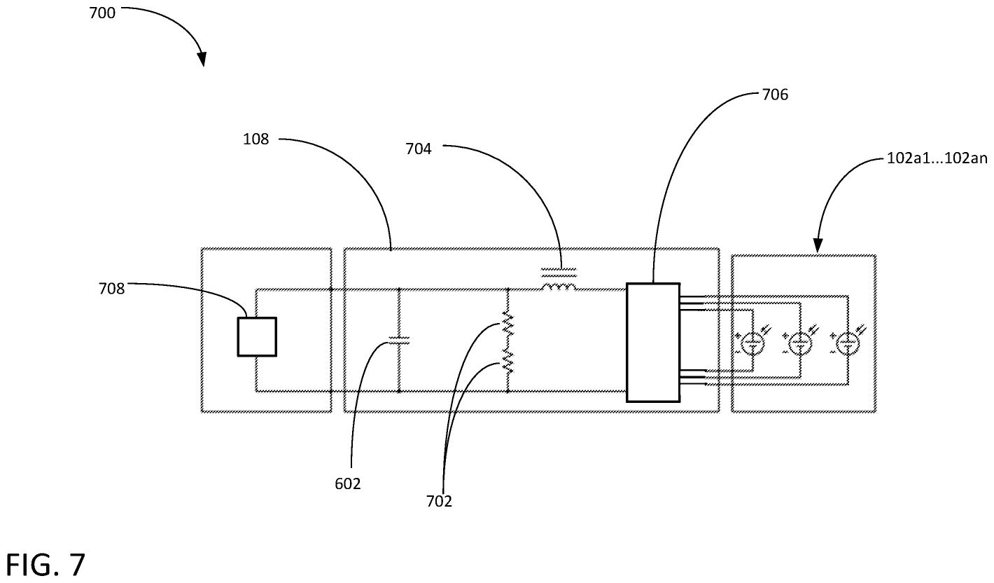

FIG. 7 shows a schematic diagram of a photovoltaic system 700, according to some embodiments. In some embodiments, the photovoltaic system 700 can be the same as or similar to the photovoltaic system 100 (FIG. 1) or the photovoltaic system 400 (FIG. 4). For purposes of this disclosure, the system is disclosed based on the photovoltaic system 100 (FIG. 1).

In the illustrated embodiment, in addition to the photovoltaic system 100, the photovoltaic system 700 includes the capacitor 602. In addition to the capacitor 602, the combiner box also includes a plurality of resistors 702 and a core 704 configured to induce the power line communication signal. Although the capacitor 602 and the plurality of resistors 702 are shown as being within the combiner 108, in some embodiments, the capacitor 602 and the plurality of resistors 702 can be adjacent to the combiner 108. In some embodiments, a device 708 is shown which can be a controller (e.g., controller 114), an inverter (e.g., inverter 110), or a transmitter (or combination thereof). For example, the capacitor 602 and the plurality of resistors 702 can be disposed near the combiner 108, e.g., between the combiner 108 and the modules 102a1 . . . 102an, between the device 708 and the combiner 108, or the like. In some embodiments, the plurality of resistors 702 can be present to, for example, discharge the capacitor 602 for electrical safety of an installer or technician. For example, in some embodiments, the capacitance can be up to 5 uF. In some embodiments, the capacitance can be up to 1 uF. In some embodiments, the capacitance can be up to 0.75 uF. In some embodiments, the capacitance can be up to 0.5 uF. In some embodiments, the capacitance can be up to 0.4 uF. In some embodiments, the capacitance can be up to 0.3 uF. In some embodiments, the capacitance can be up to 0.25 uF. In some embodiments, the capacitance can be up to 0.22 uF. In some embodiments, the capacitance can be up to 0.2 uF. In some embodiments, the capacitance can be up to 0.1 uF.

In some embodiments, the location of the capacitor 602 in the photovoltaic system 700 can enable for improved communications using the power line communications when, for example, there are long homerun cables used in the photovoltaic system 700. In some embodiments, long homerun cables can be at least 10 feet in length, at least 100 feet in length, at least 300 feet in length, at least 600 feet in length, or at least 900 feet in length. In some embodiments, including the capacitor 602 in the photovoltaic system 600 can allow the power line communication signals to remain near the modules 102. In some embodiments, this can increase a signal strength of the power line communication signal compared to prior methods. In some embodiments, the location of the capacitor 602 can also reduce a needed signal power for transmitting the power line communication signal.

In some embodiments, the combiner 108 can include a device 706. In some embodiments, the device 706 can include one or more of, a breaker such as, but not limited to, an arc fault circuit interrupter. In some embodiments, the connection between the modules 102a1 . . . 102an can be direct without inclusion of the device 706.

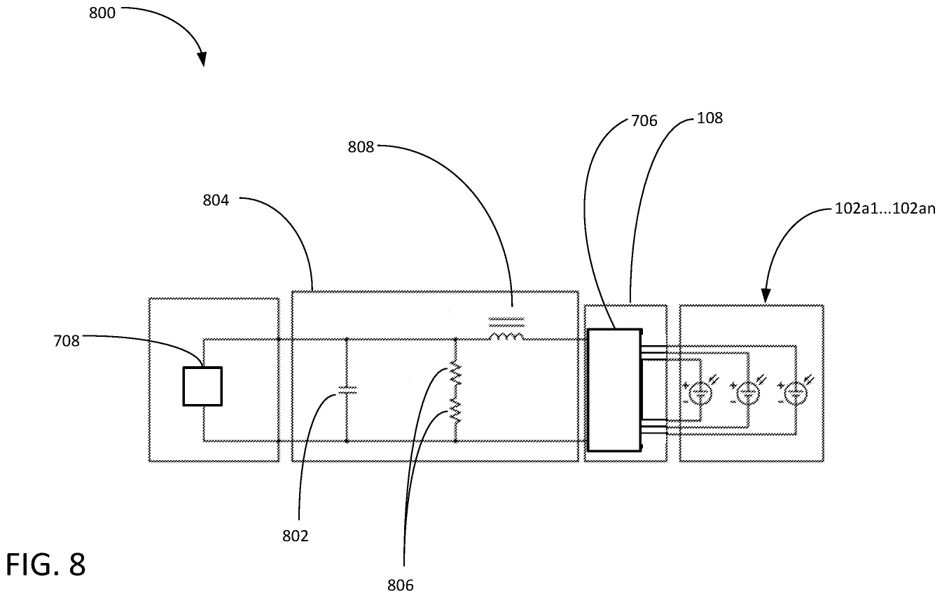

FIG. 8 shows a schematic diagram of a photovoltaic system 800, according to some embodiments. In some embodiments, the photovoltaic system 800 can be the same as or similar to the photovoltaic system 100 (FIG. 1) or the photovoltaic system 400 (FIG. 4). For purposes of this disclosure, the system is disclosed based on the photovoltaic system 100 (FIG. 1).

In the illustrated embodiment, in addition to the photovoltaic system 100, the photovoltaic system 800 includes the capacitor 802 arranged in a transmitter 804 disposed between the device 708 and the combiner 108. In addition to the capacitor 802, the transmitter 804 also includes a plurality of resistors 806 and a core 808 configured to induce the power line communication signal. In some embodiments, the plurality of resistors 806 can be present to, for example, discharge the capacitor 802 for electrical safety of an installer or technician. Although the capacitor 802 and the plurality of resistors 806 are shown as being within the transmitter 804, in some embodiments, the capacitor 802 and the plurality of resistors 806 can be adjacent to the transmitter 804. For example, the capacitor 802 and the plurality of resistors 806 can be disposed near the combiner 108, e.g., between the combiner 108 and the transmitter 804, between the transmitter 804 and the combiner 108, or the like.

In some embodiments, the capacitor 802 can have a small capacitance. For example, in some embodiments, the capacitance can be up to 5 uF. In some embodiments, the capacitance can be up to 1 uF. In some embodiments, the capacitance can be up to 0.75 uF. In some embodiments, the capacitance can be up to 0.5 uF. In some embodiments, the capacitance can be up to 0.4 uF. In some embodiments, the capacitance can be up to 0.3 uF. In some embodiments, the capacitance can be up to 0.25 uF. In some embodiments, the capacitance can be up to 0.22 uF. In some embodiments, the capacitance can be up to 0.2 uF. In some embodiments, the capacitance can be up to 0.1 uF.

In some embodiments, the location of the capacitor 802 in the photovoltaic system 800 can enable for improved communications using the power line communications when, for example, there are long homerun cables used in the photovoltaic system 800. In some embodiments, long homerun cables can be at least 10 feet in length, at least 100 feet in length, at least 300 feet in length, at least 600 feet in length, or at least 900 feet in length. In some embodiments, including the capacitor 802 in the photovoltaic system 800 can allow the power line communication signals to remain near the modules 102. In some embodiments, this can increase a signal strength of the power line communication signal compared to prior methods. In some embodiments, the location of the capacitor 802 can also reduce a needed signal power for transmitting the power line communication signal.

In some embodiments, the combiner 108 can include a device 706. In some embodiments, the device 706 can include one or more of, a breaker such as, but not limited to, an arc fault circuit interrupter. In some embodiments, the connection between the modules 102a1 . . . 102an can be direct without inclusion of the device 706.

FIG. 9 shows a schematic diagram of a photovoltaic system 900, according to some embodiments. In some embodiments, the photovoltaic system 900 can be the same as or similar to the photovoltaic system 100 (FIG. 1) or the photovoltaic system 400 (FIG. 4). For purposes of this disclosure, the system is disclosed based on the photovoltaic system 100 (FIG. 1).

In the illustrated embodiment, in addition to the photovoltaic system 100, the photovoltaic system 900 includes the capacitor 902 arranged in a string monitor 904 and capacitor 906 in a string monitor 908, the string monitor 904 and the string monitor 908 disposed between the device 708 and the combiner 108. In addition to the capacitor 902, the string monitor 904 also includes a plurality of resistors 910. A core 912 is configured to induce the power line communication signal. Similarly, the string monitor 908 includes a plurality of resistors 914. A core 916 is configured to induce the power line communication signal. In some embodiments, the plurality of resistors 910 and the plurality of resistors 914 can be present to, for example, discharge the capacitor 902 or the capacitor 906, respectively, for electrical safety of an installer or technician. In some embodiments, the capacitor 902 and the capacitor 906 can have a small capacitance. For example, in some embodiments, the capacitance can be up to 5 uF. In some embodiments, the capacitance can be up to 1 uF. In some embodiments, the capacitance can be up to 0.75 uF. In some embodiments, the capacitance can be up to 0.5 uF. In some embodiments, the capacitance can be up to 0.4 uF. In some embodiments, the capacitance can be up to 0.3 uF. In some embodiments, the capacitance can be up to 0.25 uF. In some embodiments, the capacitance can be up to 0.22 uF. In some embodiments, the capacitance can be up to 0.2 uF. In some embodiments, the capacitance can be up to 0.1 uF.

In some embodiments, the location of the capacitor 902 and the capacitor 906 in the photovoltaic system 900 can enable for improved communications using the power line communications when, for example, there are long homerun cables used in the photovoltaic system 900. In some embodiments, long homerun cables can be at least 10 feet in length, at least 100 feet in length, at least 300 feet in length, at least 600 feet in length, or at least 900 feet in length. In some embodiments, including the capacitor 902 and the capacitor 906 in the photovoltaic system 900 can allow the power line communication signals to remain near the modules 102. In some embodiments, this can increase a signal strength of the power line communication signal compared to prior methods. In some embodiments, the location of the capacitor 902 and the capacitor 906 can also reduce a needed signal power for transmitting the power line communication signal.

In some embodiments, a system includes a controller configured to generate a communication signal whose modulation represents coded information to be transmitted to a local management unit connected to a photovoltaic module; and a first local management unit configured to receive a communication signal whose modulation represents coded information from the controller, wherein the first local management unit is configured to: receive a first input communication current from a transmitter; output a first value of the first input communication current to the controller; a second local management unit configured to receive a communication signal whose modulation represents coded information from the controller, wherein the second local management unit is configured to: receive a second input communication current from the transmitter; output a second value of the second input communication current to the controller; wherein the controller is configured to: receive the first value; receive the second value; order the first value and the second value from largest to smallest to generate an ordered list; and store the ordered list in a memory of the controller, wherein the ordered list represents a relative location of the first local management unit and the second local management unit compared to the transmitter.

In some embodiments, a largest value in the ordered list indicates the corresponding one of the first local management unit and the second local management unit in the ordered list is closest to the transmitter.

In some embodiments, the ordered list is output from the controller to a remote storage via a network.

In some embodiments, the first local management unit is configured to wirelessly communicate with the controller.

In some embodiments, the second local management unit is configured to wirelessly communicate with the controller.

In some embodiments, a first signal strength of the first local management unit and a second signal strength of the second local management unit are determined by the controller.

In some embodiments, the controller is configured to order the first signal strength and the second signal strength from highest signal strength to lowest signal strength to generate an ordered signal strength list.

In some embodiments, the controller is configured to store the ordered list in the memory, wherein the ordered signal strength list represents a relative location of the first local management unit and the second local management unit compared to the controller.

In some embodiments, a largest value in the ordered signal strength list indicates the corresponding one of the first local management unit and the second local management unit in the ordered signal strength list is closest to the controller.

In some embodiments, a method includes receiving, by a controller, a first current value from a first local management unit, the first current value representative of a first input communication current to a first photovoltaic module in a photovoltaic system; receiving, by the controller, a second current value from a second local management unit, the second current value representative of a second input communication current to a second photovoltaic module in the photovoltaic system; ordering, by the controller, the first current value and the second current value to form an ordered list; and storing the ordered list in a memory of the controller, wherein the ordered list represents a relative location of the first photovoltaic module and the second photovoltaic module compared to a transmitter in the photovoltaic system.

In some embodiments, a largest value in the ordered list indicates the corresponding one of the first local management unit and the second local management unit in the ordered list is closest to the transmitter.

In some embodiments, the method includes outputting the ordered list from the controller to a remote storage via a network.

In some embodiments, the first local management unit and the second local management unit are configured to wirelessly communicate with the controller.

In some embodiments, the method includes determining, by the controller, a first signal strength of the first local management unit and a second signal strength of the second local management unit; and ordering the first signal strength and the second signal strength to generate an ordered signal strength list.

In some embodiments, the method includes storing the ordered signal strength list in the memory, wherein the ordered signal strength list represents a relative location of the first local management unit and the second local management unit compared to the controller.

In some embodiments, a method includes receiving, by a controller, a first signal strength value from a first local management unit, the first signal strength value representative of a signal strength for the first local management unit to communicate with the controller in a photovoltaic system; receiving, by the controller, a signal strength value from a second local management unit, the second signal strength value representative of a second signal strength for the second local management unit to communicate with the controller; ordering, by the controller, the first signal strength value and the second signal strength value to form an ordered signal strength list; and storing the ordered signal strength list in a memory of the controller, wherein the ordered signal strength list represents a relative location of the first photovoltaic module and the second photovoltaic module compared to the controller.

In some embodiments, a largest value in the ordered signal strength list indicates the corresponding one of the first local management unit and the second local management unit in the ordered signal strength list is closest to the controller.

In some embodiments, the method includes receiving, by a controller, a first current value from a first local management unit, the first current value representative of a first input communication current to a first photovoltaic module in a photovoltaic system; receiving, by the controller, a second current value from a second local management unit, the second current value representative of a second input communication current to a second photovoltaic module in the photovoltaic system; ordering, by the controller, the first current value and the second current value to form an ordered list; and storing the ordered list in a memory of the controller, wherein the ordered list represents a relative location of the first photovoltaic module and the second photovoltaic module compared to a transmitter in the photovoltaic system.

In some embodiments, a largest value in the ordered list indicates the corresponding one of the first local management unit and the second local management unit in the ordered list is closest to the transmitter.

In some embodiments, the method includes outputting the ordered list and the ordered signal strength list from the controller to a remote storage via a network.

In some embodiments, a system, including: a plurality of photovoltaic modules; an inverter; a controller configured to generate a signal to be transmitted to a local management unit connected to at least one of the plurality of photovoltaic modules; and a first local management unit configured to receive a communication signal from the controller, wherein the first local management unit is configured to: calculate a first input communication current; output a first value of the first input communication current to the controller; a second local management unit configured to receive a communication signal, wherein the second local management unit is configured to: calculate a second input communication current; output a second value of the second input communication current to the controller; wherein the controller is configured to: calculate the first value; calculate the second value; order the first value and the second value to generate an ordered list; and store the ordered list in a memory of the controller, wherein the ordered list represents a relative location of the first local management unit and the second local management unit.

In some embodiments, a system, wherein a largest value in the ordered list indicates a corresponding one of the first local management unit and the second local management unit in the ordered list is closest to a transmitter.

In some embodiments, a system, wherein the communication signal is a signal whose modulation represents coded information.

In some embodiments, a system, further including outputting the ordered list from the controller to a remote storage via a network.

In some embodiments, a system, wherein the first local management unit is configured to wirelessly communicate with the controller, wherein the second local management unit is configured to wirelessly communicate with the controller.

In some embodiments, a system, wherein a first signal strength of the first local management unit and a second signal strength of the second local management unit are determined by the controller.

In some embodiments, a system, wherein the controller is configured to order the first signal strength and the second signal strength from highest signal strength to lowest signal strength to generate an ordered signal strength list.

In some embodiments, a system, wherein the controller is configured to store the ordered list in the memory, wherein the ordered signal strength list represents a relative location of the first local management unit and the second local management unit compared to the controller.

In some embodiments, a system, wherein the system includes a plurality of controllers, wherein the plurality of controllers is used to determine a location of the first local management unit or the second local management unit.

In some embodiments, a method, including: receiving, by a controller, a first communication current value from a first local management unit; receiving, by the controller, a second communication current value from a second local management unit; ordering, by the controller, the first current value and the second current value to form an ordered list; and storing the ordered list in a memory, wherein the ordered list represents a relative location of the first local management unit and the second local management unit compared to a transmitter in a photovoltaic system.

In some embodiments, a method, wherein a largest value in the ordered list indicates a corresponding one of the first local management unit and the second local management unit in the ordered list is closest to the transmitter.

In some embodiments, a method, wherein the first local management unit is configured to receive a first communication signal whose modulation represents coded information.

In some embodiments, a method, wherein the first local management unit and the second local management unit are configured to wirelessly communicate with the controller.

In some embodiments, a method, further including determining or receiving, by the controller, a first signal strength of the first local management unit and a second signal strength of the second local management unit; and ordering the first signal strength and the second signal strength to generate an ordered signal strength list.

In some embodiments, a method, wherein a plurality of controllers or a plurality of receives are used to determine a location of the first local management unit or the second local management unit.

In some embodiments, a method, including: determining, by a controller, a first signal strength value from a first local management unit, the first signal strength value representative of a signal strength for the first local management unit; determining, by the controller, a signal strength value from a second local management unit, the second signal strength value representative of a second signal strength for the second local management unit; ordering, by the controller, the first signal strength value and the second signal strength value to form an ordered signal strength list; and storing the ordered signal strength list in a memory, wherein the ordered signal strength list represents a relative location of the first local management unit and the second local management unit compared to the controller.

In some embodiments, a method, wherein a plurality of controllers or a plurality of receivers are used to determine a location of the first local management unit or the second local management unit.

In some embodiments, a method, further including: receiving a first communication current value from a first local management unit, the first current value representative of a first input communication current to the first local management unit in a photovoltaic system; receiving a second communication current value from a second local management unit, the second current value representative of a second input communication current to the second local management unit in the photovoltaic system; ordering, by the controller, the first current value and the second current value to form an ordered list; and storing the ordered list in a memory, wherein the ordered list represents a relative location of the first local management unit and the second local management unit compared to a transmitter in the photovoltaic system.

In some embodiments, a method, wherein a largest value in the ordered list indicates a corresponding one of the first local management unit and the second local management unit in the ordered list is closest to the transmitter.

In some embodiments, a method, further including outputting the ordered list and the ordered signal strength list to a remote storage via a network.

In some embodiments, a system including: a plurality of photovoltaic modules; an inverter; a controller configured to generate a signal to be transmitted to a local management unit connected to at least one of the plurality of photovoltaic modules; and a first local management unit configured to receive a communication signal from the controller, wherein the first local management unit is configured to: output a message to all other connected local management units; a second local management unit configured to receive the communication signal from the first local management unit, wherein the second local management unit is configured to: output a second message to the first local management unit; wherein the controller is configured to: identify a location of the second local management unit using the second message sent to the first local management unit; and store the location in a memory of the controller, wherein the location is a relative location of the first local management unit and the second local management unit.

In some embodiments, a system, wherein when the second local management unit is parallel to the first local management unit, the second message is bit-inverted from the message.

In some embodiments, a system, wherein the communication signal is a signal whose modulation represents coded information.

In some embodiments, a system, further including outputting the location from the controller to a remote storage via a network.

In some embodiments, a system, wherein the first local management unit is configured to wirelessly communicate with the controller, wherein the second local management unit is configured to wirelessly communicate with the controller.

In some embodiments, a system, wherein a first signal strength of the first local management unit and a second signal strength of the second local management unit are determined by the controller.

In some embodiments, a system, wherein the controller is configured to order the first signal strength and the second signal strength from highest signal strength to lowest signal strength to generate an ordered signal strength list.

In some embodiments, a system, wherein the controller is configured to store the ordered list in the memory, wherein the ordered signal strength list represents a relative location of the first local management unit and the second local management unit compared to the controller.

In some embodiments, a system, wherein the system includes a plurality of controllers, wherein the plurality of controllers is used to determine a location of the first local management unit or the second local management unit.

In some embodiments, a method including: sending, by a controller, a communication to a first local management unit; sending, by the first local management unit, a second communication to a second local management unit; receiving, by the first local management unit, a third communication from the second local management unit; and storing a location of the second local management unit using the third communication.

In some embodiments, a method, wherein when the second local management unit is parallel to the first local management unit, the second message is bit-inverted from the message.

In some embodiments, a method, wherein the first local management unit is configured to receive a first communication signal whose modulation represents coded information.

In some embodiments, a method, wherein the first local management unit and the second local management unit are configured to wirelessly communicate with the controller.

In some embodiments, a method, further including determining or receiving, by the controller, a first signal strength of the first local management unit and a second signal strength of the second local management unit; and ordering the first signal strength and the second signal strength to generate an ordered signal strength list.

In some embodiments, a method, wherein a plurality of controllers or a plurality of receivers are used to determine a location of the first local management unit or the second local management unit.

In some embodiments, a system including: a plurality of photovoltaic modules; an inverter; a first local management unit configured to receive a first communication signal from the inverter; wherein the first local management includes a first communication device; wherein the first local management unit is configured to be in electrical communication with the inverter to receive power via a first wire; wherein the first local management unit is configured to be in electrical communication with the inverter to receive one or more communication signals via a second wire; wherein the second wire is separate from the first wire; a second local management unit configured to receive a second communication signal from the first local management unit; wherein the second local management includes a second communication device; wherein the second local management unit is configured to be in electrical communication with the first local management unit to receive power via a third wire; wherein the second local management unit is configured to be in electrical communication with the first local management unit to receive one or more communication signals via a fourth wire; wherein the third wire is separate from the fourth wire; wherein the fourth wire is separate from the second wire.

In some embodiments, a system, including a third local management unit, wherein the third local management unit is connected in electrical communication with the second local management unit; wherein the third local management unit is not connected in electrical communication with the first local management unit.

In some embodiments, a system, wherein the third local management unit is configured to be communicable with the inverter via communication with the second local management unit, which is in electrical communication with the first local management unit.

In some embodiments, a system, wherein communication between the first local management unit, the second local management unit, and the third local management unit is point-to-point.

In some embodiments, a system, wherein the communication between the first local management unit, the second local management unit, and the third local management unit does not use a communication bus.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A system comprising:
a plurality of photovoltaic modules;
a device configured to receive an electrical power input and provide an electrical power output;
a DC power line;
a first communication line,
wherein the first communication line is separate from the DC power line;
a second communication line,
wherein the second communication line is separate from the DC power line and separate from the first communication line;
a controller configured to generate a signal to be transmitted to a local management unit connected to at least one of the plurality of photovoltaic modules; and
a first local management unit configured to receive a communication signal from the controller, wherein the communication signal is received from the controller via the first communication line, wherein the first local management unit is configured to:
output a first message to at least one other connected local management unit;
a second local management unit configured to receive the communication signal from the first local management unit, wherein the communication signal is received from the first local management unit via the second communication line, wherein the second local management unit is configured to:
output a second message to a next local management unit, wherein the second message is output via a third communication line separate from the first communication line and separate from the second communication line;
wherein the controller is configured to:
identify a location of the first local management unit and the other connected local management units; and
wherein the location is a location of the first local management unit and the other local management units.

2. The system of claim 1, wherein the second local management unit is configured to output a third message to the first local management unit via the second communication line.

3. The system of claim 1, wherein the communication between the first local management unit and the other local management units is node-to-node.

4. The system of claim 1, wherein the controller is part of the local management unit.

5. The system of claim 1, wherein one or more of the first local management unit or the other local management units are configured to wirelessly communicate with the controller.

6. The system of claim 5, wherein a first signal strength of the first local management unit and a second signal strength of the second local management unit are used to determine the location of the respective local management unit.

7. The system of claim 6, wherein the controller is configured to order the first signal strength and the second signal strength from highest signal strength to lowest signal strength to generate an ordered signal strength list.

8. The system of claim 7, wherein the controller is configured to store the ordered list in a memory, wherein the ordered signal strength list represents a relative location of the first local management unit and the second local management unit.

9. The system of claim 1, wherein the controller is part of the device.

10. The system of claim 1, wherein the device includes at least one of a transmitter, an inverter, or a battery.

11. The system of claim 1, further comprising a disturbance unit configured to generate an electrical disturbance on the DC power line.

12. The system of claim 11, wherein the location of the first local management unit or the second local management unit is at least partially determined using the electrical disturbance on the DC power line.

13. A system comprising:
a plurality of photovoltaic modules;
a DC power line connected to the plurality of photovoltaic modules;
a device configured to receive an electrical power input and provide an electrical power output;
a disturbance generator configured to generate an electrical disturbance on the DC power line;
a plurality of local management units;
wherein a first of the plurality of local management units is configured to detect the electrical disturbance on the DC power line and determine whether the first of the plurality of local management units is electrically connected to a same string as the disturbance generator.

14. The system of claim 13, wherein the disturbance generator is the first of the plurality of local management units.

15. The system of claim 13, wherein the first of the plurality of local management units utilizes a converter to generate the electrical disturbance.

16. The system of claim 13, wherein the electrical disturbance occurs over a period of time; wherein the period of time is less than an amount of time in which an inverter adjusts to a new working point.

17. The system of claim 13, wherein the electrical disturbance is designed to not imitate at least one of shading, birds flying by, leaves, trees, or combinations thereof.

18. The system of claim 13, wherein the electrical disturbance is designed to not trigger arc fault interruption equipment.

19. The system of claim 13, wherein the disturbance generator includes at least one of a controller, an inverter, or the device.

20. The system of claim 13, further comprising a communication line which is separate from the DC power line.

21. The system of claim 13, wherein the plurality of local management units are configured to wirelessly communicate with a controller.

22. The system of claim 13, wherein a first signal strength of a first one of the plurality of local management units and a second signal strength of a second one of the plurality of local management units is used to determine locations of the first one of the plurality of local management units and the second one of the plurality of local management units.

23. A system comprising:
a plurality of photovoltaic modules;
an inverter;
a controller connected to at least one of the plurality of photovoltaic modules; and
a combiner connected to the plurality of photovoltaic modules and the inverter;
a capacitor disposed between the plurality of photovoltaic modules and the inverter, wherein the capacitor is included in or near at least one of the combiner or a string monitor,
wherein the capacitor is configured to complete a circuit to enable power line communication upstream of the inverter.

24. The system of claim 23, wherein the system comprises a transmitter; wherein the capacitor is disposed within the transmitter.

25. The system of claim 23, wherein the capacitor has a capacitance of up to 1 uF.
